(19) United States
(12) Patent Application Publication
(10) Pub. No.: US 2009/0213711 A1
(43) Pub. Date: Aug. 27, 2009

(54) METHODS APPLIED TO OPTICAL STORAGE MEDIUM FOR IDENTIFYING BOUNDARY BETWEEN AREAS STORING INFORMATION WITH DIFFERENT CHARACTERISTICS

(76) Inventor: CHIH-CHING YU, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/037,092

(22) Filed: Feb. 26, 2008

(51) Int. Cl. G11B 7/00

(52) U.S. Cl. 369/53.11

(57) ABSTRACT

A method applied to an optical storage medium for identifying a boundary between a first area and a second area is provided. The first area and the second area store information with different characteristics. The method includes moving an optical pickup unit in a radial direction for accessing the optical storage medium to generate a read-back signal, generating a feature signal according to the read-back signal detecting the feature signal to generate a plurality of detection values successively, dynamically selecting a plurality of monitored values from the detection values while the optical pickup unit is accessing the optical storage medium, and identifying the boundary between the first area and the second area according to the monitored values.

### BACKGROUND

The present invention relates to accessing information recorded on an optical disc, and more particularly, to methods applied to an optical storage medium for identifying different areas storing information with different characteristics (e.g., different densities).

Optical disc has become a popular storage medium today. An information reproducing apparatus therefore is designed to read data from or record data onto a loaded optical disc. In general, a servo system is implemented to control tracking and focusing motion of an optical pick-up unit when accessing the optical disc. Generally speaking, the parameters of the tracking servo control and the focusing servo control should be properly set to have optimum data accessing performance. In other words, if the parameters are not accurately initialized, the servo system or the read channel might become unstable. Taking the HD-DVD disc for example, a lot of information is recorded in a system lead-in area, such as the book type (disc type), disc code (disc manufacturer ID), etc. When the information reproduction apparatus (e.g., an optical disc drive) accesses an inserted disc, a mechanism of identifying the system lead-in area for reading information stored therein to adequately configure the servo parameters is required.

### SUMMARY

Methods applied to an optical storage medium for identifying different areas storing data with different characteristics (e.g., different densities) are provided. According to one embodiment of the present invention, a method applied to an optical storage medium for identifying a boundary between a first area and a second area is provided. The first area and the second area store information with different characteristics. The method includes: moving an optical pickup unit in a radial direction for accessing the optical storage medium to generate a read-back signal; generating a feature signal according to the read-back signal; detecting the feature signal to generate a plurality of detection values successively; dynamically selecting a plurality of monitored values from the detection values while the optical pickup unit is accessing the optical storage medium; and identifying the boundary between the first area and the second area according to the monitored values.

According to another embodiment of the present invention, a method applied to an optical storage medium for identifying a boundary between a first area and a second area is provided. The first area and the second area store information with different characteristics. The method includes: moving an optical pickup unit in a radial direction from an inner track toward an outer track for accessing the optical storage medium to generate a read-back signal; obtaining a feature signal according to the read-back signal; and identifying the boundary between the first area and the second area according to the feature signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an information reproduction apparatus according to an embodiment of the present invention.

FIG. 2 is a diagram illustrating general data format of an HD-DVD disc.

FIG. 3 is a diagram illustrating exemplary waveforms of signals when an optical pickup unit accesses an optical disc of a first disc type.

FIG. 4 is a flowchart illustrating an exemplary embodiment of identifying boundary of a system lead-in area.

FIG. 5 is a flowchart illustrating an exemplary embodiment of the boundary identifying scheme.

FIG. 6 is a diagram illustrating an exemplary embodiment of using detection values to identify the boundary of the system lead-in area.

FIG. 7 is a flowchart illustrating an exemplary boundary identifying scheme according to the present invention.

FIG. 8 is a flowchart illustrating an exemplary embodiment of the boundary identifying scheme.

FIG. 9 is a diagram illustrating an exemplary waveform of a feature signal.

FIG. 10 is a flowchart illustrating an exemplary embodiment of identifying the boundary of the system lead-in area.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

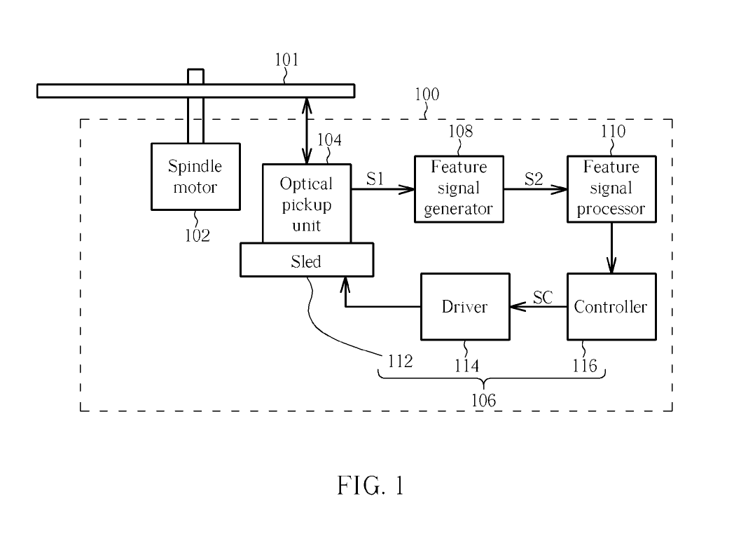

FIG. 1 is a block diagram illustrating an information reproduction apparatus 100 according to an embodiment of the present invention. The information reproduction apparatus 100 includes, but is not limited to, a spindle motor 102, an optical pickup unit 104, a moving mechanism 106, a feature signal generator 108, and a feature signal processor 110. In this embodiment, the moving mechanism 106 includes a sled 112, a driver 114, and a controller 116. When an optical storage medium (e.g., an optical disc 101) is inserted into the information reproduction apparatus 100, the spindle motor 102 rotates the optical disc 101 at a specific rotational speed.

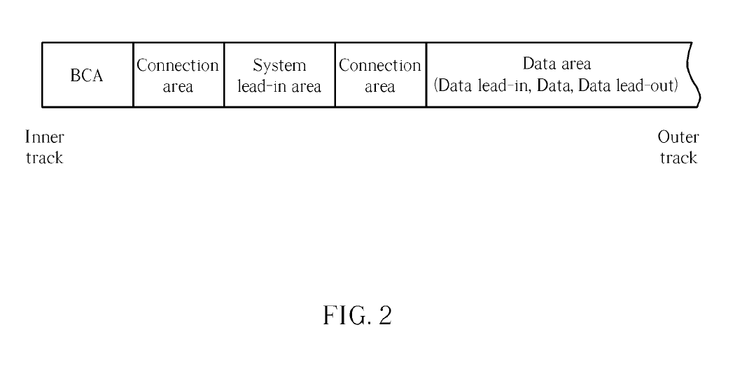

FIG. 2 is a diagram illustrating general data format of an HD-DVD disc. As shown in FIG. 2, a connection area is positioned between the system lead-in area and the data area. It should be noted that there is another connection area positioned between the system lead-in area and a burst cutting area (BCA). That is, two connection areas are respectively positioned at different sides of the system lead-in area. In general, connection area is small and negligible when compared to the burst cutting area (BCA), system lead-in area, and data area. As the system lead-in area stores information required for adequate data accessing of the loaded optical disc, it is desired to correctly and promptly identify the boundary of the system lead-in area to read information stored therein when the optical disc is loaded into the information reproduction apparatus.

The moving mechanism 106 controls the motion of the optical pickup unit 104 and the optical pickup unit 104 emits laser beam on the optical disc 101 to identify the boundary of the system lead-in area, for example, the boundary between the data area and the system lead-in area. In this embodiment, the controller 116 is a functional block supporting many fundamental functions, such as servo system control (e.g. tracking servo control and focus servo control), spindle motor control, and sled motor control. In order to locate the boundary of the system lead-in area, the controller 116 keeps outputting a control signal SC to the driver 114. Therefore, after receiving the control signal SC, the driver 114 moves the sled 112 on which the optical pickup unit 104 is disposed in response to the control signal SC. For example, the driver 114 includes a sled motor implemented for moving the sled 112 in the radial direction, from an inner track to an outer track or from an outer track to an inner track, under the control of the controller 116.

The optical pickup unit 104 is used for accessing the optical disc 101 to generate a read-back signal S1, and then the feature signal generator 108 processes the read-back signal S1 to generate a feature signal S2 for the feature signal processor 110. In this embodiment, the feature signal processor 110 plays an important role in the boundary search of the system lead-in area. Certain exemplary methods of searching for the system lead-in boundary are detailed as below.

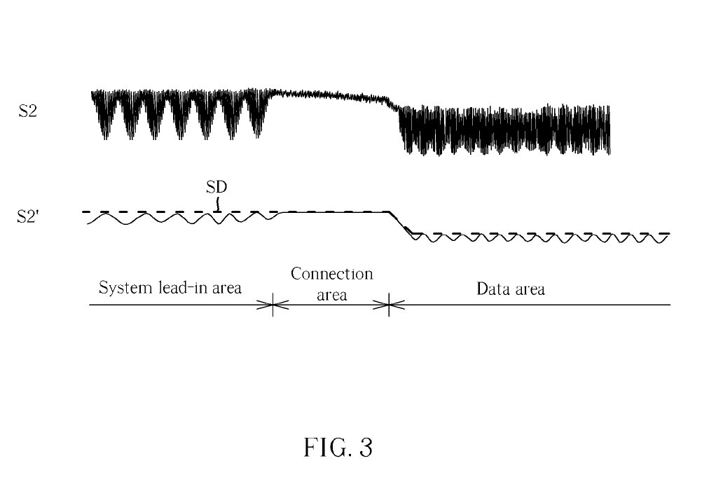

FIG. 3 is a diagram illustrating exemplary waveforms of different signals when the optical pickup unit 104 accesses the optical disc 101 of a first disc type. Assume that the optical disc 101 is an HD-DVD read-only disc (i.e., an HD-DVD ROM disc), and the feature signal S2 is a raw radio frequency (RF) signal generated from the read-back signal S1. In general, the characteristics of the system lead-in area, the data area, and the BCA area on the HD-DVD ROM disc are different. For example, a track pitch and a pit size in the system lead-in area are larger than those in the data area. In other words, the recording density in the data area is higher than that in the system lead-in area. As a result, the RF signal has different amplitude values in the BCA area, the system-lead in area, and the data area, respectively. Based on this signal characteristic, the feature signal processor 110 determines the boundary of the system lead-in area through monitoring the feature signal S2. In one embodiment, the incoming feature signal S2 is first processed by a specific signal processing operation, such as a low-pass filtering, to generate a filtered feature signal S2′, and then the filtered feature signal S2′ is monitored to locate the boundary of the system lead-in area. For clear illustration of technical features of the present invention, some examples are given as below.

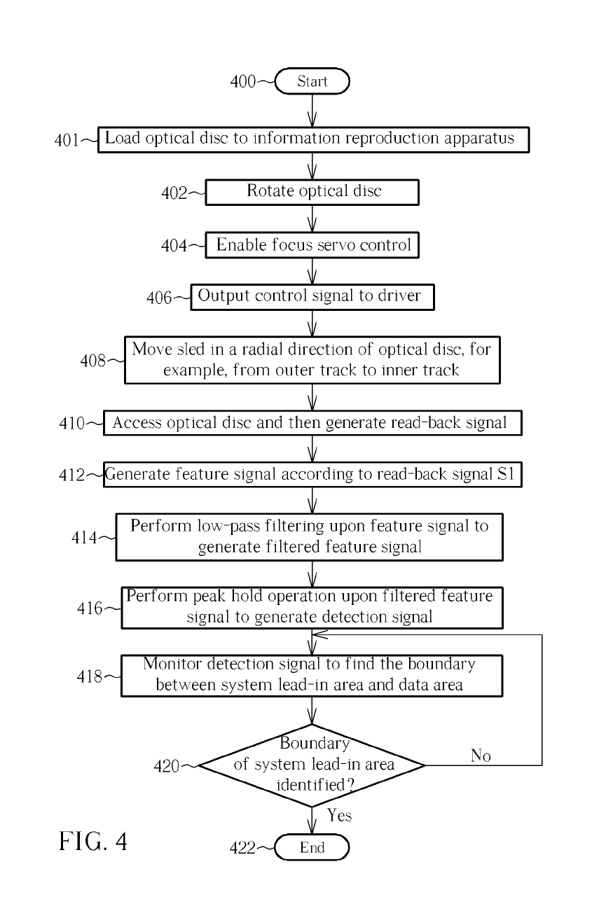

Please refer to FIG. 4 in conjunction with FIG. 1 and FIG. 3. FIG. 4 is a flowchart illustrating an exemplary method of identifying the boundary of the system lead-in area according to an embodiment of the present invention. The method of identifying the boundary of the system lead-in area is employed by the information reproduction apparatus 100 shown in FIG. 1, and includes the following steps.
Step 400: Start.
Step 401: Load the optical disc 101 (e.g., an HD-DVD ROM disc) to the information reproduction apparatus 100.

Step 402: The spindle motor 102 starts rotating the loaded optical disc 101 according to a desired rotational speed.
Step 404: The controller 116 enables the focus servo control.
Step 406: The controller 116 outputs the control signal SC to the driver 114.
Step 408: The driver 114 moves the sled 112 in a radial direction of the optical disc 101, either from inner track to outer track or from outer track to inner track. In this exemplary embodiment, the radial direction is from outer track to inner track to identify the boundary between the data area and the system lead-in area.
Step 410: The optical pickup unit 104, which is disposed on the moving sled 112, accesses the loaded optical disc 101 and generates the read-back signal S1.
Step 412: The feature signal generator 108 receives the read-back signal S1 from the optical pickup unit 104, and then generates the feature signal S2 according to the incoming read-back signal S1. In this exemplary embodiment, the feature signal S2 is a raw radio frequency (RF) signal.
Step 414: The feature signal processor 110 performs low-pass filtering upon the feature signal S2 (i.e., the raw RF signal) to generate a filtered feature signal S2′.
Step 416: The feature signal processor 110 performs a peak hold operation upon the filtered feature signal S2′ to generate a detection signal SD.
Step 418: The feature signal processor 110 monitors the detection signal SD to find the boundary between the system lead-in area and the data area.
Step 420: Is the boundary between the system lead-in area and the data area successfully identified? If yes, go to step 422; otherwise, go to step 418 to keep searching for the system lead-in boundary.
Step 422: End.

In the above exemplary method, the optical pickup unit 104 is moved in a radial direction from outer track to inner track. As indicated in FIG. 3, the boundary between the data area and the system lead-in area (the connection area is neglected) can be easily identified when the monitored detection signal SD has an amplitude change. If the amplitude drop is not detected yet, the controller 116 keeps instructing the driver 114 to move the sled 112 in the radial direction of the optical disc 101.

Steps 418 and 420 are performed to monitor the detection signal SD to detect if the boundary between the system lead-in area and the data area is encountered. In order to correctly identify the boundary of the system lead-in area, some exemplary boundary identifying schemes are given in the following.

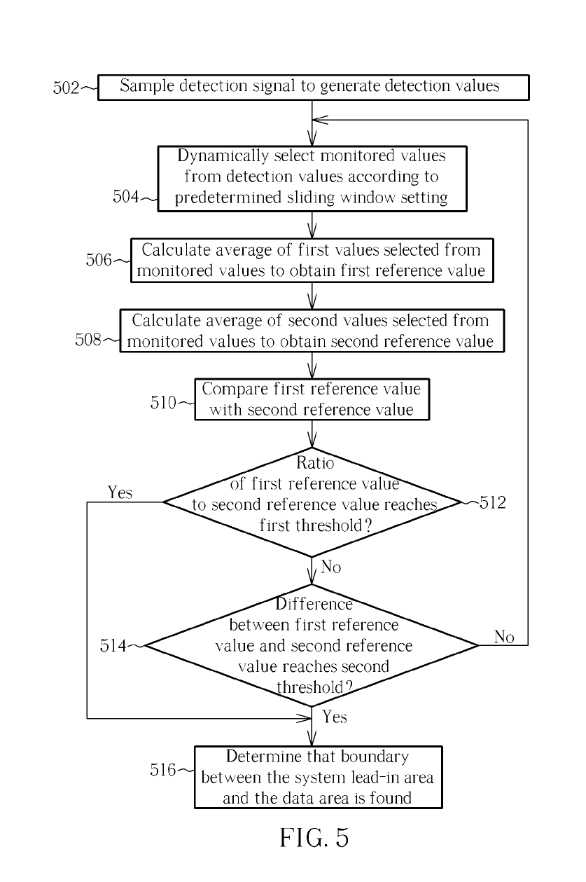

Please refer to FIG. 5. FIG. 5 is a flowchart illustrating an exemplary boundary identifying scheme according to an embodiment of the present invention. Provided that the result is substantially the same, the steps are not limited to be executed in the exact order shown in FIG. 5. The flow of the exemplary boundary identifying scheme includes following steps.
Step 502: The feature signal processor 110 samples the detection signal SD to generate a plurality of detection values, successively.
Step 504: The feature signal processor 110 dynamically selects a plurality of monitored values from the detection values according to a predetermined sliding window setting.
Step 506: The feature signal processor 110 calculates an average of a plurality of first values selected from the monitored values to obtain a first reference value.
Step 508: The feature signal processor 110 calculates an average of a plurality of second values selected from the monitored values to obtain a second reference value.
Step 510: The feature signal processor 110 compares the first reference value with the second reference value to generate a comparison result.
Step 512: Does the comparison result indicate that a ratio of the first reference value to the second reference value reaches a first threshold? If yes, go to step 516; otherwise, go to step 514.
Step 514: Does the comparison result indicate that a difference between the first reference value and the second reference value reaches a second threshold? If yes, go to step 516; otherwise, go to step 504 to keep monitoring the occurrence of the boundary of the system lead-in area.
Step 516: The feature signal processor 110 determines that the boundary between the system lead-in area and the data area is found.

The steps 418 and 420 in FIG. 4 can be realized by the flow shown in FIG. 5. FIG. 5 shows a flowchart illustrating an embodiment of dynamic boundary detecting method. In general, when the optical pickup unit 104 accesses the system lead-in area and the data area, the obtained raw RF signal has amplitude variation due to noise interference or other factors. Therefore, checking the instant amplitude of the detection signal (i.e., the result of the peak-hold operation) to locate the system lead-in boundary is sometimes unreliable. To improve the reliability of boundary detection, the exemplary boundary identifying scheme determines the boundary of the system lead-in area by considering a plurality of amplitude values gathered at a certain time period. In step 502, the feature signal processor 110 samples the detection signal SD to generate a plurality of detection values. In the embodiment shown in FIG. 4, the exemplary detection signal SD is implemented using the peak-hold output, however, the detection signal SD can be the read-back signal or feature signal in some other embodiments. That is, when the optical pickup unit 104 is moving in the radial direction for accessing the loaded optical disc 101, the feature signal processor 110 simultaneously samples the detection signal SD. The detection values are then used to identify the boundary of the system lead-in area.

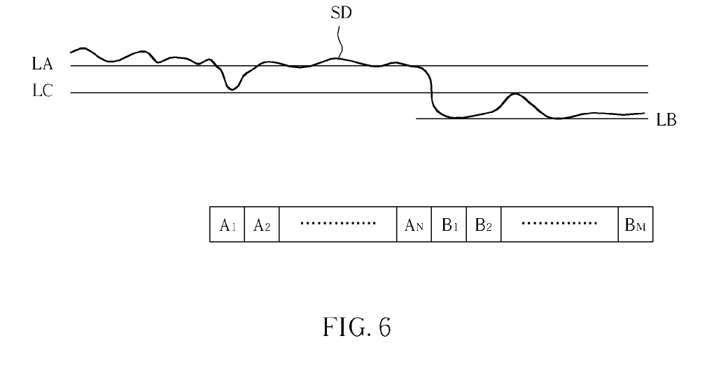

FIG. 6 is a diagram illustrating an exemplary embodiment of using detection values to identify the boundary of the system lead-in area. In this embodiment, a sliding window includes (N+M) successive detection values as monitored values. For example, in one implementation, the values N and M are both equal to five. The detection values included in the sliding window (monitored values) are continuously updated as the sliding window moves along with the movement of the optical pickup unit 104. As the sliding window design is a common practice to those skilled in the signal processing field, further description of the implementation of the sliding window is omitted for brevity.

After the detection values are selected as monitored values using the sliding window, certain signal processing operations are applied. In steps 506 and 508, an average of the N monitored values (LA shown in FIG. 6) in the current sliding window and an average of the M monitored values (LB shown in FIG. 6) in the current sliding window are computed as a first reference value and a second reference value respectively. Then, the feature signal processor 110 compares average LA and average LB to check if the ratio of average LA to average LB reaches a first threshold or a difference between average LA and average LB reaches a second threshold (steps 512, 514). If either of the conditions is met, the feature signal processor 110 determines that the optical pickup unit 104 just passed the boundary of the system lead-in area. For example, when average LA is 1.5 times as great as average LB according to the current sliding window setting shown in FIG. 6, the feature signal processor 110 determines that the system lead-in boundary is found. As shown in FIG. 6, monitor values A_{N} and B₁are used to identify the boundary of the system lead-in area (step 516). It should be noted that the sliding window setting shown in FIG. 6 is for illustrative purpose only. For example, the size of the sliding window is programmable depending upon design requirements. In some embodiments, the feature signal processor 110 only checks the ratio between averages LA and LB for boundary detection, and in some other embodiments, the feature signal processor 110 only checks the difference between the two averages for boundary detection.

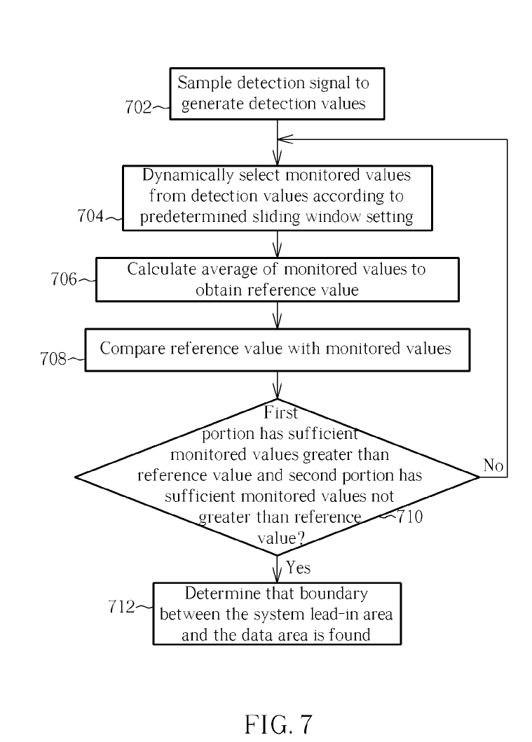

The above embodiment shows one way to detect a visible change in the steady state of the detection values, which is not meant to be a limit to the invention, as those skilled in the art should be able to implement some other algorithms that are also capable of detecting a steady state change of the detection values. For example, an exemplary boundary identifying scheme shown in FIG. 7 is another possible implementation for detection of the steady state change. Provided that the result is substantially the same, the steps are not limited to be executed in the exact order shown in FIG. 7. The flow of the exemplary boundary identifying scheme includes following steps.
Step 702: The feature signal processor 110 samples the detection signal SD to generate a plurality of detection values.
Step 704: The feature signal processor 110 dynamically selects a plurality of monitored values from the detection values according to a predetermined sliding window setting.
Step 706: The feature signal processor 110 calculates an average of the monitored values to obtain a reference value.
Step 708: The feature signal processor 110 compares the reference value with the monitored values to generate a comparison result.
Step 710: Does the comparison result indicates that a total number of monitored values in a first portion that are greater than the reference value reaches a first threshold and a total number of monitored values in a second portion that are not greater than the reference value reaches a second threshold? If yes, go to step 712; otherwise, go to step 704 to keep monitoring the detection values.
Step 712: The feature signal processor 110 determines that the boundary between the system lead-in area and the data area is found.

Steps 418 and 420 in FIG. 4 can be realized by the flow shown in FIG. 7. Similarly, the exemplary boundary identifying scheme shown in FIG. 7 refers to monitoring a plurality of amplitude values to check if the boundary of the system lead-in area is encountered. In step 702, the feature signal processor 110 samples the detection signal SD (for example, the peak-hold output) to generate a plurality of detection values. That is, when the optical pickup unit 104 is moving in the radial direction for accessing the loaded optical disc 101, the feature signal processor 110 samples the detection signal SD generated by performing peak-hold operation upon the raw RF signal (i.e., the feature signal S2). The detection values are then used to identify the boundary of the system lead-in area. For example, as shown in FIG. 6, a sliding window includes (N+M) successive detection values as monitored values, where the size of the sliding window is programmable depending on design requirements. The detection values included in the sliding window are continuously updated when the optical pickup unit 104 is moving in the radial direction of the optical disc 101. In step 706, an average of the (N+M) monitored values (LC) in the current sliding window is computed as a reference value. The feature signal processor 110 compares average LC and monitored values A₁-B_{M} included in the current sliding window. As mentioned above, when the optical pickup unit 104 accesses the system lead-in area and the data area while moving from inner track to outer track of the disc, the obtained raw RF signal might have amplitude variation due to noise interference or other factors. In this embodiment, a total number of monitored values in a first portion that are greater than the reference value (e.g., average LC) is computed, and a total number of monitored values in a second portion that are less than the reference value (e.g., average LC) is computed as well.

The first portion and second portion of the sliding window are used for identify the system lead-in area and the data area respectively in this embodiment. If the total number of monitored values in aforementioned first portion that are greater than average LC) reaches a first threshold, and the total number of monitored values in the aforementioned second portion that are less than average LC reaches a second threshold, the feature signal processor 110 determines that the boundary of the system lead-in area is encountered. For example, assume that values M and N are both five and the first and second thresholds are both three. When at least three monitored values in the first portion (monitored values A₁-A_{N}) are greater than average LC, and at least three monitored values in the second portion (monitored values B₁-B_{M}) are less than average LC, the feature signal processor 110 determines the first portion and the second portion in the current sliding window correspond to the system lead-in area and the data area respectively. As a result, monitor values A_{N} and B₁shown in FIG. 6 are identified as the boundary of the system lead-in area (step 712). In some other embodiments, the optical pick-up unit moves from outer track to inner track, so the data area is accessed before the system lead-in area. Step 710 of FIG. 7 is thus modified to check if the first portion has sufficient monitored values less than the reference value while the second portion has sufficient monitored values greater than the reference value.

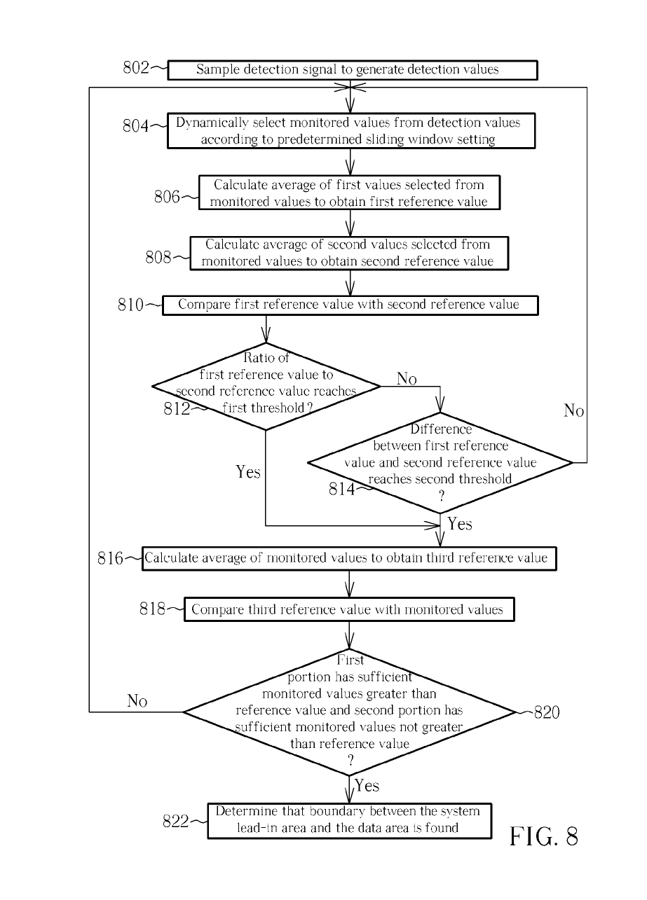

In an embodiment shown in FIG. 8, the boundary detection rules illustrated in FIG. 5 and FIG. 7 are both implemented to locate a boundary between areas storing data with different density, such as the boundary between data area and system lead-in area. Provided that the result is substantially the same, the steps are not limited to be executed in the exact order shown in FIG. 8. The flow of the exemplary boundary identifying scheme includes following steps.
Step 802: The feature signal processor 110 samples the detection signal SD to generate a plurality of detection values, successively.
Step 804: The feature signal processor 110 dynamically selects a plurality of monitored values from the detection values according to a predetermined sliding window setting.
Step 806: The feature signal processor 110 calculates an average of a plurality of first values selected from the monitored values to obtain a first reference value.
Step 808: The feature signal processor 110 calculates an average of a plurality of second values selected from the monitored values to obtain a second reference value.
Step 810: The feature signal processor 110 compares the first reference value with the second reference value to generate a first comparison result.
Step 812: Does the first comparison result indicate that a ratio of the first reference value to the second reference value reaches a first threshold? If yes, go to step 816; otherwise, go to step 814.
Step 814: Does the first comparison result indicate that a difference between the first reference value and the second reference value reaches a second threshold? If yes, go to step 816; otherwise, go to step 804 to keep monitoring the occurrence of the boundary of the system lead-in area.
Step 816: The feature signal processor 110 calculates an average of the monitored values to obtain a third reference value.
Step 818: The feature signal processor 110 compares the third reference value with the monitored values to generate a second comparison result.
Step 820: Does the second comparison result indicates that a total number of monitored values in a first portion that are greater than the reference value reaches a first threshold and a total number of monitored values in a second portion that are not greater than the reference value reaches a second threshold? If yes, go to step 822; otherwise, go to step 804 to keep monitoring the occurrence of the boundary of the system lead-in area.
Step 822: The feature signal processor 110 determines that the boundary between the system lead-in area and the data area is found.

As a person skilled in the art can readily understand operation of each step in FIG. 8 after reading above disclosure, further description is omitted here for the sake of brevity.

It should be noted that the aforementioned exemplary boundary identifying schemes shown in FIGS. 5-8 are not limited to identify the boundary between the system lead-in area and the data area. In other embodiments, the exemplary boundary identifying schemes shown in FIGS. 5-8 can be applied to identify the boundary between the system lead-in area and the BCA area or the boundary between any two areas with different characteristics (e.g., different data densities). Additionally, in the above embodiments, the exemplary boundary identifying schemes shown in FIGS. 5-8 monitors the peak hold output (i.e., the detection signal SD) to detect the occurrence of the boundary of the system lead-in area. However, this is not meant to be a limitation of the present invention. For example, in other embodiments, the feature signal processor 110 employs one of the exemplary boundary identifying schemes shown in FIGS. 5-8 to directly monitor the feature signal S2 or a resultant signal generated from processing the feature signal S2 according to a specific signal processing operation (e.g., a bottom hold operation) different from the aforementioned peak hold operation, to thereby detect the occurrence of the boundary. This still obeys the spirit of the present invention, and falls in the scope of the present invention.

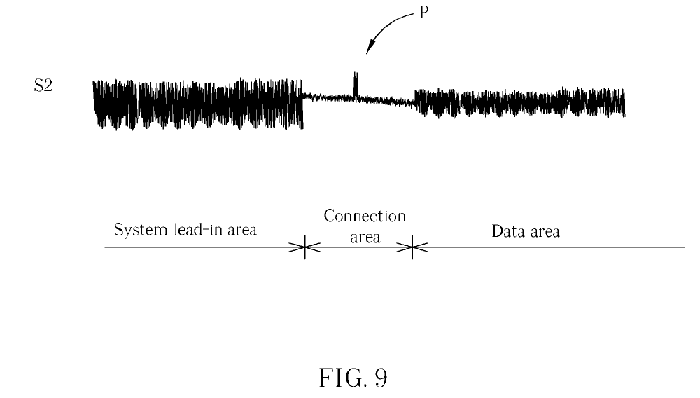

FIG. 9 is a diagram illustrating an exemplary waveform of the obtained feature signal S2 when the optical pickup unit 104 accesses the optical disc 101of a second disc type, for example, HD-DVD recordable/rewritable disc, and the feature signal S2 is a raw radio frequency (RF) signal generated from the read-back signal S1. A typical HD-DVD recordable/rewritable disc has an optimum power control (OPC) area (e.g., the drive test zone defined in the disc specification) arranged in the data lead-in area of the data area. The RF signal (i.e., the feature signal S2) corresponding to the data area may have a spike portion P as shown in FIG. 9. The spike portion P increases the difficulty in identifying the boundary between the system lead-in area and the data area. In other words, in a case where the connection area is negligible and the feature signal S2 (e.g., the raw RF signal) is directly monitored to identify the boundary when the optical pickup unit is moving in a radial direction from the data area (outer track) to the system lead-in area (inner track), an erroneous boundary detection result might be obtained due to the spike portion P in the RF signal.

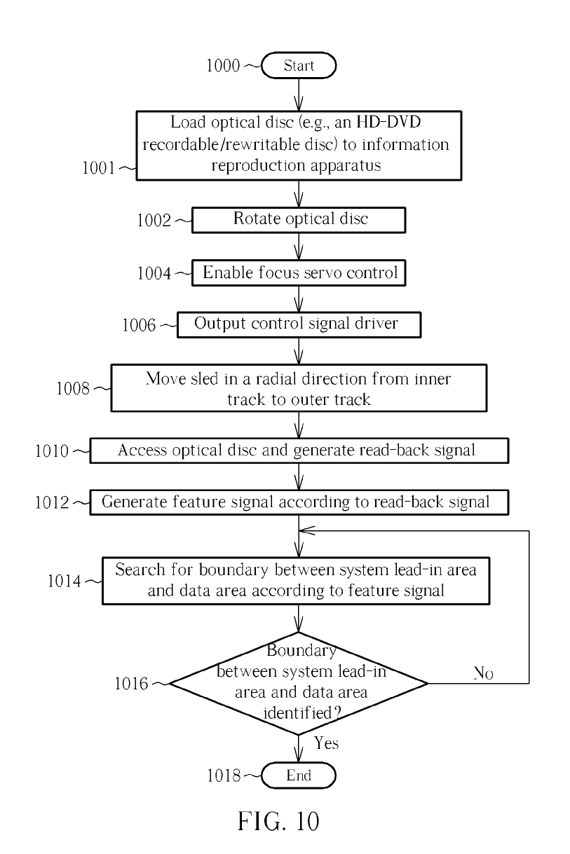

Please refer to FIG. 10 in conjunction with FIG. 1and FIG. 9. FIG. 10 is a flowchart illustrating an exemplary method of identifying the boundary of the system lead-in area according to the present invention. The method of identifying the boundary of the system lead-in area may be employed by an information reproduction apparatus 100 as shown in FIG. 1.
Step 1000: Start.
Step 1001: Load the optical disc 101 (e.g., an HD-DVD recordable/rewritable disc) to the information reproduction apparatus 100.
Step 1002: The spindle motor 102 starts rotating the loaded optical disc 101 according to a desired rotational speed.
Step 1004: The controller 116 enables the focus servo control.
Step 1006: The controller 116 outputs the control signal SC to the driver 114.
Step 1008: The driver 114 moves the sled 112 in a radial direction of the optical disc 101, where the radial direction is from the inner track to the outer track in this embodiment.
Step 1010: The optical pickup unit 104, disposed on the moving sled 112, accesses the loaded optical disc 101 and generates the read-back signal S1.
Step 1012: The feature signal generator 108 receives the read-back signal S1 from the optical pickup unit 104, and then generates the feature signal S2 according to the incoming read-back signal S1.
Step 1014: The feature signal processor 110 searches for the boundary between the system lead-in area and the data area according to the feature signal S2.
Step 1016: Is the boundary between the system lead-in area and the data area identified successfully? If yes, go to step 1018; otherwise, go to step 1014.
Step 1018: End.

As the optical pickup unit 104 is moving in the radial direction from the system lead-in area to the data area (i.e., from an inner track to an outer track) during the boundary search procedure, the reliability of boundary detection can be improved when interferences or noises (e.g., the spike portion P shown in FIG. 9) are presence. In this embodiment, the feature signal S2 generated in step 1012 is a raw radio frequency (RF) signal. However, using other signals generated from processing the read-back signal S1 are also feasible, depending upon design requirements. For example, in alternative designs of the present invention, the feature signal S2 could be a radio frequency ripple (RFRP) signal, servo control signal such as the tracking error (TE) signal, etc.

Furthermore, in step 1014, the feature signal processor 110 directly monitors the received feature signal S2 to find the boundary between the system lead-in area and the data area. However, in other embodiments of the present invention, the feature signal processor 110 can process the received feature signal S2 according to a specific signal processing operation (e.g., the above-mentioned low-pass filtering operation), and then monitor the resultant feature signal to find the boundary between the system lead-in area and the data area. Additionally, one of the exemplary boundary identifying schemes shown in FIGS. 5-8 can be employed in steps 1014 and 1016 to improve the boundary identification accuracy. Above alternative designs all obey the spirit of the present invention, and fall in the scope of the present invention.

It should be noted that identifying a boundary between two optical disc areas with different characteristics is not limited to identifying a boundary between two areas with different data densities. For example, the exemplary boundary identifying schemes mentioned above could be implemented to identify a boundary between one optical disc area having an RF signal produced when read by the optical pickup unit 104 (e.g., an area on an optical disc that includes data stored therein) and another optical disc area having no RF signal produced when read by the optical pickup unit 104 (e.g., a blank area on the optical disc). In other words, as one output generated from accessing a non-blank area and the other output generated from accessing a blank area have different magnitude characteristics, the aforementioned boundary identifying schemes could be used to identify the boundary between the non-blank area and the blank area of a specific optical disc.

Regarding a recordable optical disc, an OPC area is generally formed thereon. For example, the OPC area is located between a data area and a system lead-in area on the recordable optical disc. As known to those skilled in the art, the OPC area could be a blank area if no OPC operation is performed thereto, or a non-blank area if the OPC operation has been performed thereto. To correctly identify the boundary of the system lead-in area, additional judging steps applied to the detection signal generated by the feature signal processor 110 can be employed. For instance, the amplitude of the detection signal generated from accessing the OPC area is smaller than the amplitude of the detection signal generated from accessing either of the data area and the system lead-in area. Therefore, based on the above-mentioned boundary identifying schemes including monitoring the peak hold value/bottom hold value and/or monitoring values included in a sliding window/monitor window, a peak hold value/bottom hold value extended check or a sliding window/monitor window extended check is devised and used for identifying and skipping the OPC area between the data area and the system-lead-in area, thereby improving the accuracy of identifying the boundary of the system lead-in area on the recordable optical disc. This alternative design also falls in the scope of the present invention.

Those skilled in the art will readily observe that numerous modifications and alterations of the device and method may be made while retaining the teachings of the invention.

What is claimed is:

1. A method applied to an optical storage medium for identifying a boundary between a first area and a second area, the first area and the second area storing information with different characteristics, the method comprising:
moving an optical pickup unit in a radial direction for accessing the optical storage medium to generate a read-back signal;
generating a feature signal according to the read-back signal;
detecting the feature signal to generate a plurality of detection values successively;
dynamically selecting a plurality of monitored values from the detection values while the optical pickup unit is accessing the optical storage medium; and
identifying the boundary between the first area and the second area according to the monitored values.

2. The method of claim 1, wherein the first area and the second area store information with different densities.

3. The method of claim 1, wherein the step of detecting the feature signal to generate the detection values comprises:
filtering the feature signal to generate a filtered feature signal;
performing a peak or bottom hold operation according to the filtered feature signal to thereby generate a detection signal; and
detecting the detection signal to generate the detection values.

4. The method of claim 1, wherein the feature signal is a raw radio frequency (RF) signal.

5. The method of claim 1, wherein the step of identifying the boundary between the first area and the second area according to the monitored values comprises:
obtaining a first reference value according to a plurality of first values selected from the monitored values;
obtaining a second reference value according to a plurality of second values selected from the monitored values;
comparing the first reference value and the second reference value to generate a comparison result; and
identifying the boundary between the first area and the second area according to the comparison result.

6. The method of claim 5, wherein the step of identifying the boundary between the first area and the second area according to the comparison result comprises:
identifying the boundary between the first area and the second area when the comparison result indicates that a ratio of the first reference value to the second reference value reaches a predetermined threshold.

7. The method of claim 5, wherein the step of identifying the boundary between the first area and the second area according to the comparison result comprises:
identifying the boundary between the first area and the second area when the comparison result indicates that a difference between the first reference value and the second reference value reaches a predetermined threshold.

8. The method of claim 1, wherein the step of identifying the boundary between the first area and the second area according to the monitored values comprises:
obtaining a reference value according to the monitored values;
comparing the reference value and the monitored values to generate a comparison result; and
identifying the boundary between the first area and the second area according to the comparison result.

9. The method of claim 8, wherein the monitored values are divided into a first portion and a second portion, and the step of identifying the boundary between the first area and the second area according to the comparison result comprises:
identifying the boundary between the first area and the second area when the comparison result indicates that a total number of monitored values in the first portion that are greater than the reference value reaches a first threshold and a total number of monitored values in the second portion that are less than the reference value reaches a second threshold.

10. A method applied to an optical storage medium for identifying a boundary between a first area and a second area, the first area and the second area storing information with different characteristics, the method comprising:
moving an optical pickup unit in a radial direction from an inner track toward an outer track for accessing the optical storage medium to generate a read-back signal;
obtaining a feature signal according to the read-back signal; and
identifying the boundary between the first area and the second area according to the feature signal.

11. The method of claim 10, wherein the first area and the second area store information with different densities.

12. The method of claim 10, wherein the step of identifying the boundary between the first area and the second area according to the feature signal comprises:
filtering the feature signal to generate a filtered feature signal;
performing a peak or bottom hold operation according to the filtered feature signal to thereby generate a detection signal; and
monitoring the detection signal to identify the boundary between the first area and the second area.

13. The method of claim 10, wherein the feature signal is a raw radio frequency (RF) signal.

14. The method of claim 10, wherein the step of identifying the boundary between the first area and the second area according to the feature signal comprises:
detecting the feature signal to generate a plurality of detection values successively;
dynamically selecting a plurality of monitored values from the detection values while the optical pickup unit is accessing the optical storage medium; and
identifying the boundary between the first area and the second area according to the monitored values.

15. The method of claim 14, wherein the step of identifying the boundary between the first area and the second area according to the monitored values comprises:
obtaining a first reference value according to a plurality of first values selected from the monitored values;
obtaining a second reference value according to a plurality of second values selected from the monitored values;
comparing the first reference value and the second reference value to generate a comparison result; and
identifying the boundary between the first area and the second area according to the comparison result.

16. The method of claim 15, wherein the step of identifying the boundary between the first area and the second area according to the comparison result comprises:
identifying the boundary between the first area and the second area when the comparison result indicates that a ratio of the first reference value to the second reference value reaches a predetermined threshold.

17. The method of claim 15, wherein the step of identifying the boundary between the first area and the second area according to the comparison result comprises:
identifying the boundary between the first area and the second area when the comparison result indicates that a difference between the first reference value and the second reference value reaches a predetermined threshold.

18. The method of claim 14, wherein the step of identifying the boundary between the first area and the second area according to the monitored values comprises:
obtaining a reference value according to the monitored values;
comparing the reference value and the monitored values to generate a comparison result; and
identifying the boundary between the first area and the second area according to the comparison result.

19. The method of claim 18, wherein the monitored values are divided into a first portion and a second portion, and the step of identifying the boundary between the first area and the second area according to the comparison result comprises:
identifying the boundary between the first area and the second area when the comparison result indicates that a total number of monitored values in the first portion that are greater than the reference value reaches a first threshold and a total number of monitored values in the second portion that are less than the reference value reaches a second threshold.
